(19) United States
(12) Patent Application Publication
(10) Pub. No.: US 2006/0110834 A1
(43) Pub. Date: May 25, 2006

(54) Real-time monitoring the variation of dye solution in the process of a polarizer

(75) Inventors: Yi-Ping Wang, Tao-Yuan (TW); Yao-Chung Cheng, Tao-Yuan (TW); Shih-Ming Chen, Tao-Yuan (TW)

Correspondence Address: BIRCH STEWART KOLASCH & BIRCH, PO BOX 747, FALLS CHURCH, VA, 22040-0747, US

(73) Assignee: Optimax Technology Corporation

(21) Appl. No.: 11/079,085

(22) Filed: Mar. 15, 2005

(30) Foreign Application Priority Data
Nov. 19, 2004 (TW) 093135589

(51) Int. Cl. G01N 31/22

(52) U.S. Cl. 436/164

(57) ABSTRACT

A method of real-time monitoring the variation of dye solution in the process of a polarizer is provided that an ion chromatography is utilized to measure the variation of a reduction in the dye solution and analyze the components therein; moreover, an ion meter is utilized to measure the concentration of the dye solution.

### BACKGROUND OF THE INVENTION

1. Field of the Invention

The present invention relates to a method for monitoring the variation of the process of a polarizer, and more particularly to a method for real-time monitoring the variation of dye solution in the process of a polarizer.

2. Description of the Related Art

The function of a polarizing sheet or polarizing film comprising polarizing or filtering most of natural light/white light and allowing only certain light with desired direction to pass through depends on the material dyed on the polarizing sheet. Generally speaking, iodine type polarizing films are most commonly utilized in liquid crystal displays (LCDs). If polarizing sheets are removed from a LCD, light can arbitrarily pass through liquid crystal lying between a thin-film transistor (TFT) substrate and a liquid crystal display (LCD) substrate when an electric field is not applied. Once polarizing sheets are added in a LCD, the amount of light passing through the LCD can be determined by the liquid crystal's rotation controlled by the added electric field thus the brightness contrast control of the LCD is achieved.

Polarizing films can be substantially sorted as absorptive type and reflective type. Absorptive polarizing films can be further categorized as O-type, E-type, metal grid type, iodine type and dye type polarizing films. Dye type and iodine type polarizing films are formed by using the diffusion of I₃⁻ and I₅⁻ or dye molecules into a macromolecule polymer film, such as a polyvinyl alcohol (PVA) film, and owing to the regular arrangement of I₃⁻ and I₅⁻ or dye molecules, light travels in directions parallel to the direction of the arrangement of I₃⁻ and I₅⁻ or dye molecules is absorbed, while light travels in directions perpendicular to the direction of the arrangement of I₃⁻ and I₅⁻ or dye molecules passes through. Typical thin film transistor liquid crystal displays (TFT-LCDs) use dye type and iodine type polarizing films each of which includes a polyvinyl alcohol (PVA) film being extended to have a thickness of several decades millimeter and a upper and a lower protective films such as triacetyl-cellulose (TAC) films covering the PVA film to form a polarizing film with a sandwich structure.

In a polarizing film, an iodine and an iodine ion of potassium iodide would form a brown iodine complex ion, and the iodine complex ion can be reduced to achromatic iodine ion through a reducing reaction process by reductants such as sodium thiosuflate (Na₂S₂O₃) or vitamin C. Since the polarizing film uses iodine and potassium iodide as the main material and the concentration and content of iodine complex ions are crucial, the concentration and content of iodine complex ions after the reducing reaction is performed would influence the dye quality of the polarizing film. Thus there is an inevitable need to develop a method for real-time monitoring the concentration and content of iodine complex ions of dye solution in the process of a polarizer to monitor the process of a polarizing film more effectively and save the use of dye solution.

### BRIEF SUMMARY OF THE INVENTION

It is therefore an object of the invention to provide a method for monitoring the variation of concentration and content of compositions of dye solution in the process of a polarizer which utilizes Ion Chromatography to test the oxidation-reduction reaction of iodine ions and real-time monitor the consumption of iodine ions and the timing of replacing the dye solution.

It is another object of this invention to provide a method for monitoring the variation of concentration and content of compositions of dye solution in the process of a polarizer which utilizes Ion Chromatography to analyze the content of impurities of chemical raw material so as to further control the concentration and content of iodine ions in the polarizing film.

It is a further object of this invention to provide a method for monitoring the variation of concentration and content of compositions of dye solution in the process of a polarizing film which utilizes Ion Chromatography to test the concentration of iodine ions in the polarizing film so as to effectively control the use of the dye solution.

To achieve these objects, and in accordance with the purpose of the invention, the invention provides a method for monitoring the variation of concentration and content of compositions of dye solution in a polarizing film. The method comprises the following steps. First of all, a dye solution including iodine complex ions and iodine ions is provided. Then the iodine complex ions of the dye solution are reduced to iodine ions via a reductant. Next, the reduction reaction of the dye solution is tested and qualitatively analyzed the composition of the dye solution by Ion Chromatography. Finally, the concentration of iodine complex ions of the dye solution is tested by an ion concentration analyzer

It is to be understood that both the foregoing general description and the following detailed description are exemplary and explanatory only and are not restrictive of the invention, as claimed.

### BRIEF DESCRIPTION OF THE DRAWINGS

The present invention is understood by reference to the following detailed description.

### DETAILED DESCRIPTION OF THE INVENTION

It is to be understood and appreciated that the method described below do not cover a complete method. The present invention can be practiced in conjunction with various techniques that are used in the art, and only so much of the commonly elements are included herein as are necessary to provide an understanding of the present invention.

The invention discloses a method for real-time monitoring the variation of the concentration of the compositions of a dye solution in the process of a polarizing film. The method qualitatively analyzes the composition of the dye solution and quantitatively analyzes the concentration and content of iodine ions of the dye solution by Ion Chromatography, wherein the conductivity is 21.02 micron second, the pressure is 1496 psi, and the flow speed is 1.20 milliliter/minute. The principle of Ion Chromatography is to utilize anion ions of a sample dye solution together with a sodium carbonate and sodium bicarbonate solution to pass through a serial of ion exchange tubes of Ion Chromatography, and then the anion ions would be isolated owing to the different affinities with low capacity strong-base/alkali ion exchange resins. The isolated anion ions then flow through a restrain device of a high capacity cation exchange resin and are transformed to have a status of high conductivity acid. The sodium carbonate and sodium bicarbonate solution is transformed to have a status of low conductivity carbonic acid. The transformed anion ions can be qualitatively and quantitatively analyzed by determining the retaining time and the wave peak area of conductivity chart after the anion ions flow through a conductivity detector.

Therefore, Ion Chromatography utilizes the difference of ion exchange ability of different ions to isolate ions of a solution after flowing through tubes filled with ion exchange resins and then the transformed anion ions can be qualitatively and quantitatively analyzed by determining the retaining time and the wave peak area of conductivity chart.

The invention adds sodium carbonate and sodium bicarbonate into 2000 milliliters deionized water to form a sodium carbonate and sodium bicarbonate solution. Table 1 shows the purity, weight and conductivity of the sodium carbonate and sodium bicarbonate solution.

TABLE 1

| | sodium carbonate | sodium bicarbonate |
|---|---|---|
| chemicals | (Na₂CO₃) | (NaHCO₃) |
| purity | >99% | >99% |
| weight | 0.7462 gm | 0.1686 gm |
| conductivity | 16-25 μsec | >21 15500 μsec |

The method for real-time monitoring the variation of the compositions of a dye solution in the process of a polarizing film uses Ohm's law and the different conductivities of anion and cation ions resulting from the different activities of anion and cation ions to qualitatively and quantitatively analyze iodine ions of the dye solution. The principle of isolating ions is based on the different timing of appearance.

The iodine ion solution of the invention is formed by adding iodine into a potassium iodide solution and dilute the potassium iodide solution with deionized water 2 to 1,000,000 times of volume, and preferably 10 to 500,000 times of volume. Since the solubility of iodine in water is about 3 gm/liter and iodine is hard to dissolve in water, iodine is dissolved in deionized water with the assistance of supersonic wave agitation. Furthermore, the invention uses vitamin C as reductant and 1 gm vitamin C is dissolved in deionized water and is diluted with deionized water to 100 milliliters, and 0.2 milliliter reductant is added into the iodine ion solution each time.

In the preferred embodiment of the invention set forth, the iodine and potassium iodide solution is diluted with deionized water and is injected into an Ion Chromatography apparatus, and the iodine ion solution is added with vitamin C reductant to proceed a reduction reaction and is injected into the Ion Chromatography apparatus for analyzing. Table 2 shows the result of analysis and it shows that the preferred times of volume of deionized water added into the iodine and potassium iodide solution for diluting is 50,000 times.

TABLE 2

| | times of volume | time interval of | |
|---|---|---|---|
| | for diluting | wave peak | area |
| iodine solution | 10 | 12.78-18.43 | 281552534.68 |
| iodine solution with | 10 | — | — |
| vitamin c reductant | | | |
| iodine solution | 100 | 18.99-26.51 | 26013962.81 |
| iodine solution with | 100 | 17.45-24.88 | 477446052.00 |
| vitamin c reductant | | | |
| iodine solution | 1000 | 21.05-24.93 | 2592849.20 |
| iodine solution with | 1000 | 20.65-24.70 | 3759461.20 |
| vitamin c reductant | | | |
| iodine solution | 50000 | 20.08-22.20 | 367433.00 |
| iodine solution with | 50000 | 19.7-22.28 | 723464.68 |
| vitamin c reductant | | | |
| iodine solution | 500000 | 20.99-21.83 | 15318.2 |
| iodine solution with | 500000 | 20.22-22.15 | 134612.8 |
| vitamin c reductant | | | |

Since the process of polarizing sheet uses iodine and potassium iodide as main materials, it is crucial to realize the real-time variation of iodine ions for the process of polarizing sheet. As shown in table 2, the reduction of iodine ions can be clearly observed through the Ion Chromatography apparatus. The reduction reactions of iodine ions present in similar time intervals. For example, the time interval of wave peak of the iodine solution diluted with deionized water having 50,000 times of volume is similar to other iodine solutions. Moreover, the iodine solution diluted with deionized water having 50,000 times of volume presents a time interval of wave peak similar to other iodine solutions after adding vitamin C reductant for reduction reaction so that the iodine complex ions after being reduced and the iodine ions before being reduced can be qualitatively analyzed.

Furthermore, the areas of curves of the iodine solutions of different dilution ratios change significantly before the reduction reaction (I₃⁻) and after the reduction reaction (I⁻). Thus, because the invention utilizes vitamin C as reductant for reducing iodine complex ions to iodine ions, quantitative analyses of oxidation and reduction reaction of iodine can be achieved by deducting the area before the reduction reaction from the area after the reduction reaction. Therefore, the invention can simply and rapidly examine the oxidation and reduction reaction of iodine ion by an Ion Chromatography apparatus.

After qualitatively examining iodine complex ions and iodine ions, the invention can also utilize an ion concentration analyzer and iodine ion selective electrodes to calculate and determine the concentrations of iodine complex ions each solution tank including dye elongate compensate tank. Moreover, the invention uses standard addition to obtain electric potentials of iodine ions and to calculate the concentration of the iodine complex ions by Nerst equation.

In the method of analyzing the iodine complex ions by Ion Chromatography, the iodine ion solution containing iodine complex ions and iodine ions is diluted with deionized water with a volume ratio 1:100. Then the concentration of the iodine ion solution is analyzed by an iodine ion selective electrode analysis. Next several decades milliliters of vitamin C are added into several decades milliliters of the iodine ion solution to reduce iodine complex ions to iodine ions so that iodine complex ions of the iodine ion solution are reduced to iodine ions. Then the concentration of the reduced iodine ion solution is analyzed by an iodine ion selective electrode analysis. Next the concentration of iodine complex ions can be obtained by deducting the concentration of iodine ions before reduction from the concentration of iodine ions after reduction. Table 3 shows the results.

TABLE 3

| | | | After |
|---|---|---|---|
| | | | reduction (ppm) − before |
| | Before | After | reduction (ppm)/ |
| | reduction | reduction | After |
| concentration | (ppm) | (ppm) | reduction (ppm) |
| Dye tank | 7.92 | 10.23 | 0.226 |
| | 8.19 | 10.49 | 0.219 |
| | 9.20 | 11.41 | 0.194 |
| | 8.97 | 11.06 | 0.189 |
| | 9.56 | 12.42 | 0.230 |
| | 9.75 | 11.95 | 0.184 |
| | 9.86 | 12.00 | 0.178 |
| | 9.95 | 12.31 | 0.192 |
| | 10.72 | 12.38 | 0.134 |
| | 10.10 | 12.29 | 0.178 |
| | 10.27 | 12.38 | 0.170 |
| | 10.39 | 12.70 | 0.182 |
| | 11.23 | 12.75 | 0.119 |
| Elongate tank | 191.00 | 196.00 | 0.026 |
| | 191.00 | 196.00 | 0.026 |
| | 191.00 | 196.00 | 0.026 |
| | 193.00 | 200.00 | 0.035 |
| | 193.00 | 200.00 | 0.035 |
| | 193.00 | 199.00 | 0.030 |
| | 193.00 | 200.00 | 0.035 |
| | 193.00 | 200.00 | 0.035 |
| | 193.00 | 200.00 | 0.035 |
| | 194.00 | 200.00 | 0.030 |
| | 192.00 | 200.00 | 0.040 |
| | 193.00 | 201.00 | 0.040 |
| | 189.00 | 197.00 | 0.041 |
| Compensate | 276.00 | 277.00 | 0.004 |
| tank | 269.00 | 272.00 | 0.011 |
| | 269.00 | 271.00 | 0.007 |
| | 265.00 | 267.00 | 0.007 |
| | 270.00 | 272.00 | 0.007 |
| | 270.00 | 271.00 | 0.004 |
| | 267.00 | 271.00 | 0.015 |
| | 271.00 | 273.00 | 0.007 |
| | 268.00 | 270.00 | 0.007 |
| | 262.00 | 266.00 | 0.015 |
| | 263.00 | 267.00 | 0.015 |
| | 263.00 | 265.00 | 0.008 |
| | 258.00 | 261.00 | 0.011 |

Since the ratio of iodine complex ions in the dye tank is the highest one, it can be verified that the dye reaction is presents in the dye tank.

Since the process of polarizing film permeate iodine complex ions into a polyvinyl alcohol (PVA) film, the concentration of iodine complex ions is crucial in the process of polarizing film. By using Ion Chromatography and ion concentration analysis to monitor the variation of the concentration of iodine ion, the dye result of polarizing film can be determined by real-time control and adjust the concentration of iodine ions so as to determine the timing of replacing the dye solution without any additional adjustment of concentration of iodine ions in the elongate and compensate tanks so that the use of the dye solution can be effectively saved.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A method for real-time monitoring variations of contents of a dye solution in a process of a polarizing film, said method comprising:
providing a diluted dye solution including iodine complex ions and iodine ions;
adding a reductant into said dye solution to perform a reduction reaction;
performing a qualitative analysis by an Ion Chromatography apparatus to analyze said reduction reaction;
performing a quantitative analysis by an ion concentration analysis apparatus to determine a concentration of said iodine complex ions.

2. The method according to claim 1, wherein said reductant comprises vitamin C.

3. The method according to claim 1, wherein said reduction reaction comprises a step of adding said reductant into said diluted dye solution to reduce said iodine complex ions to said iodine ions.

4. The method according to claim 1, wherein said diluted dye solution is diluted with deionized water.

5. The method according to claim 4, wherein said deionized water diluted dye solution has a dilution ratio of 1:50000.

6. The method according to claim 1, further comprises a step of analyzing said diluted dye solution by an iodine ion selective electrode analysis.

7. The method according to claim 1, wherein said qualitative analysis comprises a step of determining concentrations of said diluted dye solution before said reduction reaction and after said reduction reaction respectively by said ion concentration analysis apparatus.

8. The method according to claim 7, wherein said concentration of iodine complex ions is determined by deducting said concentration of said diluted dye solution before reduction from the concentration of said diluted dye solution after reduction.
